(19) United States
(12) Patent Application Publication
(10) Pub. No.: US 2007/0153768 A1
(43) Pub. Date: Jul. 5, 2007

(54) Apparatus and method for cordless internet protocol

(76) Inventors: Balakumar Jagadesan, Glendale Heights, IL (US); Sanjay Gupta, Lakewood, IL (US)

Correspondence Address: MOTOROLA INC, 600 NORTH US HIGHWAY 45, ROOM AS437, LIBERTYVILLE, IL, 60048-5343, US

(21) Appl. No.: 11/322,714

(22) Filed: Dec. 30, 2005

(51) Int. Cl. H04L 12/66

(52) U.S. Cl. 370/352; 370/401

(57) ABSTRACT

A mobile station (323) may register with a base set (301) to access a fixed line service, such as broadband IP network (315), to make and receive calls. When the mobile station (323) is within a radio coverage area of access point (313), it may seamlessly register itself and receive calls placed to a home phone number. Mobile station (323) may initiate a call using either its own MSISDN of the MSISDN of the base set (301), but not both. A second mobile station (327) registered with base set (301) may participate in the same call, acting as an extension line. In this manner, home base (301) provides a user cordless phone experience similar to having cordless extension phones connected to a PSTN line.

### CROSS-REFERENCE TO RELATED APPLICATIONS

The present disclosure is related to co-pending U.S. patent application Ser. No. 11/086006 (filing date Mar. 22, 2005) “ADAPTER FOR ACCESSING CELLULAR SERVICES FROM A NON-CELLULAR DEVICE,” which is assigned to the same assignee as the present application, and which is hereby incorporated by reference herein.

### FIELD OF THE DISCLOSURE

The present disclosure relates generally to voice and data communications over an Internet Protocol (“IP”) network and more particularly to an apparatus for voice over IP communication from a non-cellular device to a cellular communication network.

### BACKGROUND

Existing systems are capable of communicating voice calls over digital communications networks, such as an Internet Protocol (“IP”) network. For example, an analog phone may be coupled to a voice-over-IP (“VoIP”) phone. Cordless handsets for use with Public Switched Telephone Networks (“PSTNs”) may make use of “Cordless IP” (“CoIP”) for communicating with a base-set, where the base-set provides a conversion of IP voice packets from the handset, to protocols suitable for the PSTN or for various cellular networks such as, but not limited to, CDMA, TDMA, GSM, GPRS, UMTS, CDMA2000, etc. Additionally or alternatively, the handset may be capable of communicating with various wireless broadband (“WiBB”) or wireless local area networks (“WLANs”) using interfaces such as 802.16, 802.11, or Bluetooth™, or any other unlicensed radio interface.

In any event, a cordless phone may use IP to communicate with a base-set. In a household or business environment, multiple users may each possess their own mobile phone for cellular, WiBB, or WLAN communications. Therefore, in a household for example, each user would need to have a separate account for wireless and would not be able to make use of a PSTN connection simultaneously with other family members.

Some cellular technologies employ Subscriber Identity Modules (SIMs), also referred to as “SIM cards” which contain a user profile and other dynamic network related information related to a subscriber including an MSISDN. Mobile stations for 3G networks may support two MSISDNs in the same physical SIM card with two user profiles tied to the same International Mobile Station Identity (IMSI). This feature facilitates billing models in which, for example, office and home calls may be differentiated for billing purposes based on the distinct user profiles. However, such capabilities not available in older generation mobile stations for example GSM mobile stations.

Standardization efforts have focused on mobile users at their customer premises, such that an unlicensed radio link on a home network or WLAN may make use of a broadband IP network for access to the Core Network. The Unlicensed Mobile Access (UMA) standard is one such effort, and describes the extension of GSM/GPRS service by tunneling the relevant protocols over broadband IP. Various goals may be achieved by such systems including lower costs as well as enhanced network coverage and services.

### BRIEF DESCRIPTION OF THE DRAWINGS

FIG. 1 is a diagram illustrating a communications system in accordance with the Unlicensed Mobile Access (UMA) standards.

FIG. 2 is a block diagram illustrating the software stacks in accordance with UMA standards.

FIG. 3 is a diagram illustrating a communications system in accordance with some embodiments.

FIG. 4 is a message flow diagram illustrating operation in accordance with some embodiments.

FIG. 5 is a software stack diagram in accordance with some embodiments.

FIG. 6 is a flow diagram illustrating operation of a base set in accordance with an embodiment.

FIG. 7 is a flow diagram illustrating operation of call control signaling in accordance with an embodiment.

FIG. 8 is a flow diagram illustrating operation of call control signaling in accordance with an alternative embodiment to FIG. 7.

FIG. 9 is a flow diagram illustrating operation of a mobile station in accordance with some embodiments.

### DETAILED DESCRIPTION

Methods and apparatuses which provide user access to various communications services using a cellular wireless device are provided herein.

In the various embodiments herein disclosed, a mobile station may register with a base set to access a fixed line service, such as a Public Switched Telephone Network (PSTN) or broadband IP network, to make and receive calls.

A first aspect of the present disclosure is a base set and mobile station for providing cordless functionality in a home or small business network where several mobile stations may register with the home or small business network and function as extension phones.

A second aspect of the present disclosure is a base set and mobile station wherein the same mobile station may be used to access multiple subscriptions due to features provided by the base set, for example accessing a home or small business network and also a cellular subscription associated with the mobile station.

A third aspect of the present disclosure are the methods associated with the first and second aspects.

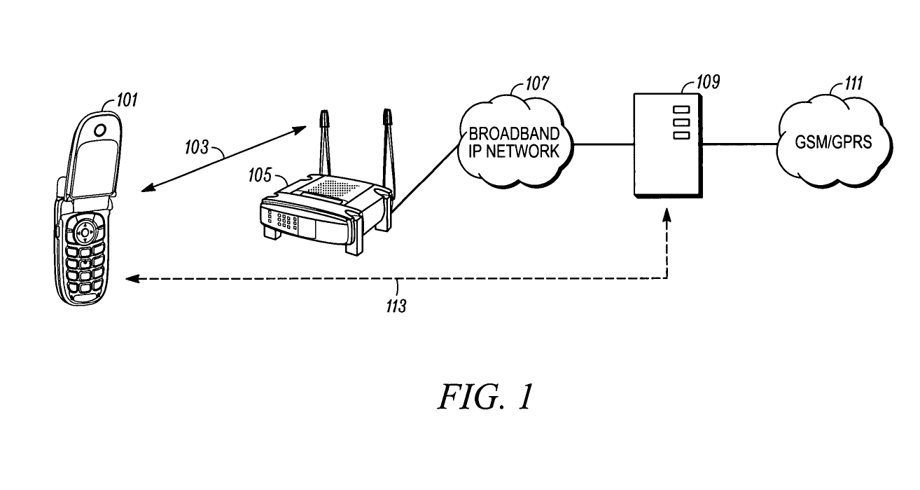

Turning now to the figures, FIG. 1 is a block diagram of a network in accordance with the Unlicensed Mobile Access (UMA) Functional Architecture. Mobile station 101 is capable of communicating with a cellular network, using for example GSM/GPRS, and an unlicensed radio interface 103 such as, but not limited to, 802.11 or Bluetooth™.

Mobile station 101 may therefore communicate with access point (AP) 105 using the unlicensed radio link 103, which may be 802.11, Bluetooth™, or other suitable unlicensed wireless interface. AP 105 is connected to a Broadband IP Network 107, which may be accomplished by any suitable connection including cables, or other wireless connection.

UMA Network Controller (UNC) 109 communicates with the AP 105 via Broadband IP network 107. The UNC 109 appears to the GSM/GPRS network 111, as a base station subsystem, that is, as at least one base transceiver station (BTS) and a base station controller (BSC). The UNC 109 may also comprise a Security Gateway (SGW) that enables secure remote access tunneling from mobile station 101, via mutual authentication, encryption and data integrity for signaling, voice and data traffic.

The UMA standards also define an interface between the mobile station 101 and UNC 109 as the “Up interface” 113. The UMA architecture standards however, do not provide details on the AP 105 or Broadband IP Network 107 functionalities, which are outside the UMA scope. In any case, interface 113 between the mobile station 101 and the UNC 109 is an IP connection.

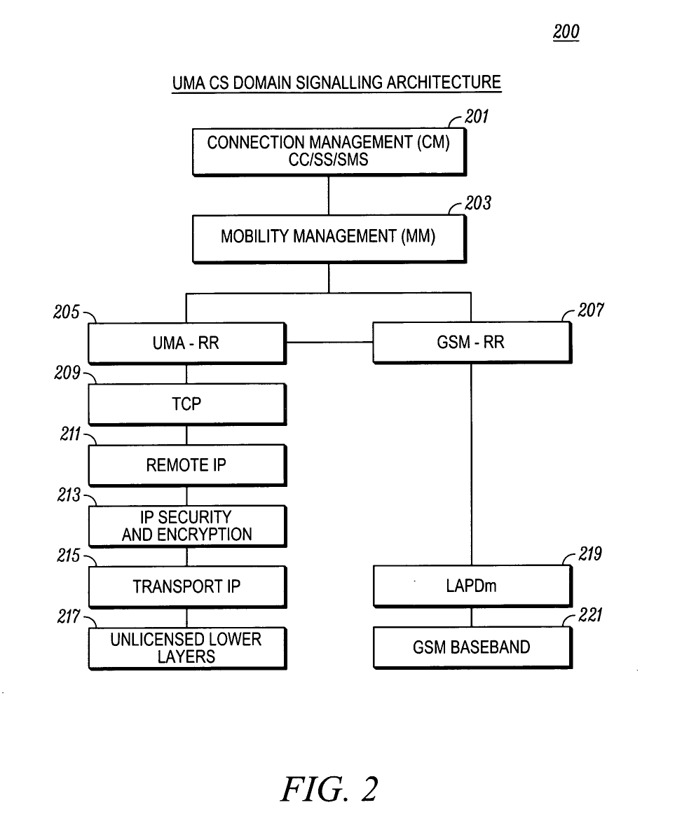

FIG. 2 illustrates the software stacks operating within mobile station 101. It is to be understood that much of the inventive functionality and many of the inventive principles herein disclosed are best implemented with or in software or firmware programs or instructions and integrated circuits (ICs) such as digital signal processors (DSPs) or application specific ICs (ASICs) as is well known by those of ordinary skill in the art. Further, the inventive functionality herein disclosed may be considered modules coupled to, or operating on or in, the various ICs, DSPs, ASICs, etc., or combinations of such IC, DSP, and/or ASICs. Therefore, further discussion of such software, firmware and ICs, if any, will be limited to the essentials with respect to the principles and concepts used by the various embodiments.

Returning now to FIG. 2 and beginning with the higher stack layers, mobile station 101 has a Connection Management (CM) layer 201 which further comprises Call Control (CC), signaling (SS) and short-message-service (SMS) components. Mobile station 101 further has a Mobility Management (MM) layer 203, which communicates with at least two radio interface capabilities, for example a UMA-RR (UMA—“Radio Resource”) 205 for unlicensed spectrum, and a GSM-RR 207 for cellular communications.

Under the UMA-RR layer, the mobile device 101 stack has layers for communication over IP including TCP layer 209, Remote IP 211, IP security and encryption layer 213, and Transport IP layer 215. Unlicensed Lower Layers 217, are related to the specific radio interface employed, for example 802.11 or Bluetooth™, and will therefore comprise layers suitable for such employed interface.

On the cellular side, under the GSM-RR 207 layer, are layers suitable for communicating over the cellular air interface, for example LAPDm layer 219 and a GSM baseband layer 221. The UMA-RR layer 205 and GSM-RR layer 207 peer as necessary for functions such as handovers between the two radio networks.

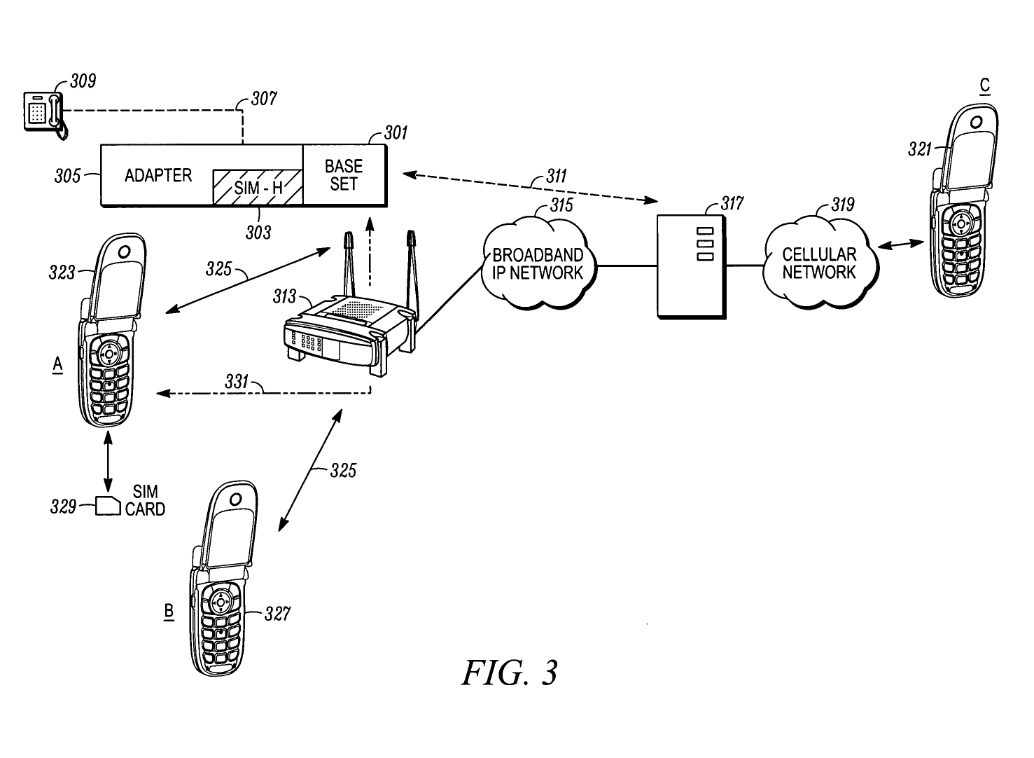

FIG. 3 illustrates a communication system in accordance with some embodiments. A base set 301 may be integrated with an adapter 305. Adapter 305 comprises a home Subscriber Identity Module (SIM-H) 303, which defines a subscriber account with cellular network 319. In other words, base set 301 may appear to cellular network 319 as a subscriber, independent of mobile stations 323, 327 and 321.

Adapter 305 may have connection ports suitable for wired connections such as connection 307 from telephone 309. Connection 307 may use standard RJ-11 connectors. Telephone 309 may be a POTS telephone or may be a VoIP phone. If telephone 309 is a POTS phone, then adapter 305 will create voice packets and assemble the voice packets using a suitable protocol for transmission over the Broadband IP network 315 over connection 311. Additionally, adapter 305 provides conversion between wireless protocols used by mobile stations “A” 323 and “B” 327, such that the mobile stations and telephone 309 act as extension lines on a common connection such as in a home or business environment.

Mobile stations A and B, 323 and 327 respectively, each have an individual SIM card, for example SIM card 329 which has a user profile and other dynamic network related information related to subscriber A including subscriber A's MSISDN for cellular network 319. Mobile stations 323 and 327 also each have modules for registration with the base set 301, for selecting the base set 301 number to place and receive calls when registered, and to transmit a call control confirmed (CONFIRMED CC) message to base set 301. The mobile stations 323 and 327 also have a module to receive Subscribe Identity Module (SIM) information via an information download from base set 301. This particular module provides a virtual SIM functionality on the mobile stations.

The various embodiments are best understood with respect to use case descriptions as follows. In FIG. 3, a user A, with a CoIP handset 323 enters home from the office. The user A's home has base set 301 which has an independent GSM mobile subscription (SIM-H 303) and a unique MSISDN. The base set 301 MSISDN may be used to receive and make calls for residential purposes.

Therefore, when user A mobile station 323 is within a radio coverage area of access point 313, mobile station 323 may seamlessly register itself in the home network. Mobile station 323 may then receive calls placed to a home phone number. Mobile station 323 may also initiate a call using either its own MSISDN or the MSISDN of the base set 301, but not both.

In a second use case, mobile station 323 may place a call to mobile station 321. Mobile station 321 in this case is outside of the home network coverage area, or is otherwise not a participant in the home network of mobile stations 323 and 327. Mobile station 327 is registered with base set 301 and therefore may participate in the same call, acting as an extension line. In this manner, home base 301 provides a user cordless phone experience similar to having cordless extension phones connected to a PSTN line. Voice communication from mobile station 321 to mobile station 323 and mobile station 327 is multiplexed by base set 301 and broadcast over the unlicensed air interface 325. Likewise, voice communications from mobile station 325 and 327 are multiplexed by the base set and transmitted over the network to mobile station 321.

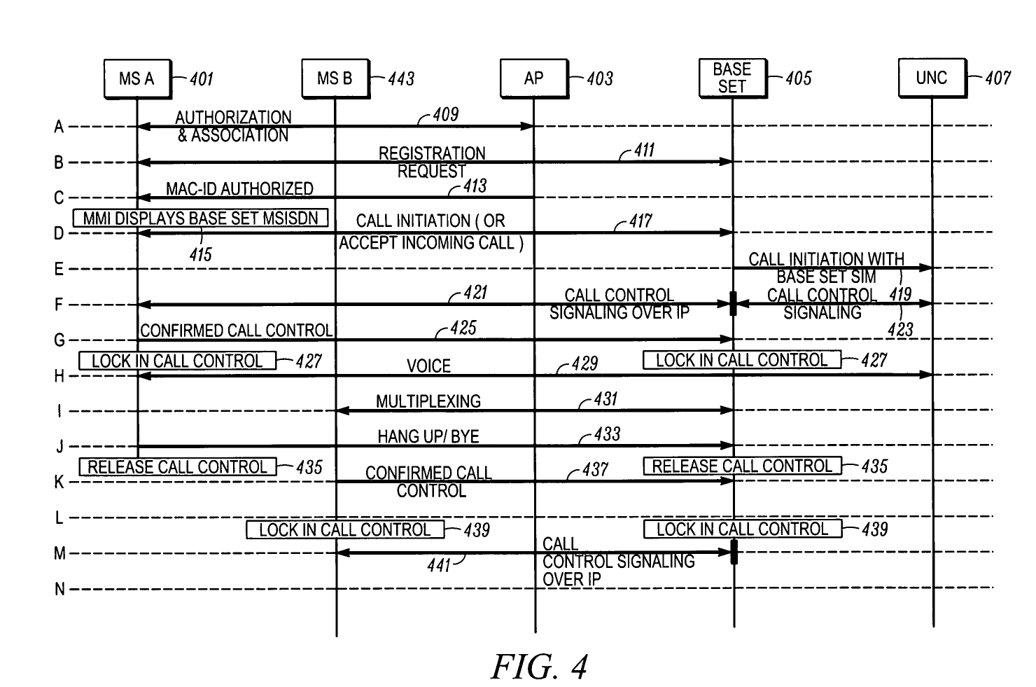

In the various embodiments, an inventive interface 331 is utilized which provides the functionality in the respective planes as further described herein and illustrated by FIG. 4. In the second use case described above, mobile station 325 maintains call control signaling for the call and such call control signaling is transferred over interface 331 to the base set for communication over the connection 311 to UNC 317, and ultimately to cellular network 319.

Mobile stations, such as mobile station 401, may either automatically or manually register with the WLAN network, via AP 403, using user-defined profiles, location or network search, corresponding to the MSISDN at home.

During the registration process, the mobile station 401 associates and authenticates 409 with AP 403 and then sends a special registration request 411 to the base set 405. Base set 405 authenticates the mobile station 401 using the mobile station 401 MAC-ID which has been pre-programmed into AP 403. The AP 403 then acknowledges that the mobile station 401 MAC-ID is authorized via message 413.

Further, during authentication, the base set 405 may transfer some of the SIM related parameters over the air in a secure fashion.

At the completion of the mobile station 401 registration with AP 403, the mobile station 401 will provide an additional display prompt 415 that reflects the MSISDN of the base set 405. Therefore a user of mobile station 401 may choose to make the base set 405 MSISDN the primary number at home and could use mobile station 401 to place and receive calls from and to the home phone number, respectively.

The mobile station 401 therefore functions as a wireless phone on a wireless network, such as a cellular network, when away from the home network, and functions as a cordless extension phone when within the home network.

Returning now to FIG. 4, the mobile station 401 may place a call, or receive an incoming call. The call initiation 417 may be accomplished by, for example, transmitting the appropriate DTMF tones or other call initiation as understood by one of ordinary skill. The base set 405 receives the call initiation message 417 and carries on the call initiation with the UNC 407 via message 419 which uses the bases set 405 SIM-H information.

The mobile station 401 establishes call control signaling 421 over IP which is passed over to the UNC 407 by the base set 405 via 423 as shown. Important to note is that, on the uplink channel, the base set 405 only intercepts call control signaling 421 messages for further composition of Mobility Management (MM) and lower layer header data prior to re-routing to the UNC 407 via messaging 423.

The mobile station 401 sends a call control confirmation message 425 and locks in the call control 427 preventing any other mobiles registered in the home network from accessing the call control signaling. A voice channel 429 may then be established between mobile station 401 and the UNC 407 and ultimately with the called party (not shown).

Important to note in that the base set 405 multiplexes the voice channel 429 of mobile station 401 with any other mobile station, such as mobile station 443, that is registered on the home network. Therefore, mobile station 443 may participate in the call via multiplexed channel 431. Additionally, any telephone units connected to the base set are multiplexed into the call such that the telephone units act as phone extensions. Therefore, a telephone such as telephone 309 illustrated in FIG. 3 could also participate in the call.

In the user data plane, the multiplexed data between the base set 405 and UNC 407 is encrypted as appropriate. Data broadcast to the mobile stations may use any appropriate WLAN broadcast methodology. Additionally, data broadcast from the base set 405 to the mobile stations or wired telephone units utilizes echo cancellation as understood by one of ordinary skill.

In the various embodiments the UNC 407 will only be aware of the IMSI, IMEI, location and relevant registration information of the MSISDN of the base set 405. Any mobiles stations registered with the home network will be transparent to the UNC 407.

Returning now to FIG. 4, mobile station 401 may subsequently hang up, and transmit a hang-up receiver message 433, which may be a BYE message or a Session Initiation Protocol (SIP) BYE message in some embodiments, to the base set 405. The mobile station 401 may then release its monopoly on call control signaling as shown in block 435.

The mobile station 443, which was previously acting only as an extension phone, may subsequently transmit a call control confirmation message 437, and lock in call control 439 such that any other registered mobile stations, or connected wired telephones, may only act as extension phones. Call control signaling 441 now proceeds between mobile station 443 and base set 405.

From the perspective of UNC 407 however, the call control signaling 423 appears constant with respect to the base set 405, and the change of call control from mobile station 401 “A” to mobile station 443 “B” is transparent.

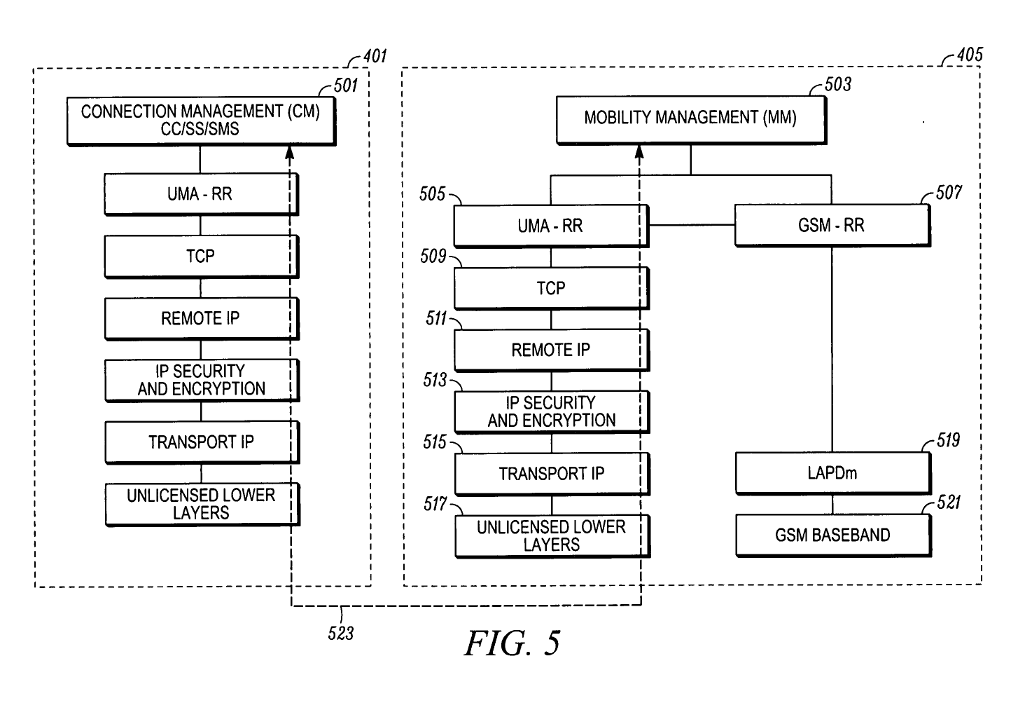

Turning now to FIG. 5, further details of the control plane extensions of the various embodiments are illustrated.

In a first embodiment, a GSM subscriber component of base set 405 will perform all the functionality associated with GSM and/or UMA layers MM (mobility management) 503 and lower. Therefore, the base set 405 may have a UMA-RR 505, TCP 509, Remote IP 511, IP security and encryption 513, and IP Transport 515 layers as well as further lower layers for unlicensed radio 517 links such as but not limited to Bluetooth™, and/or 802.11, etc. The base set 405 may additionally, or may alternatively, have a GSM-RR 507 layer, a LAPDm 519 layer and a GSM baseband 521 layer.

For incoming calls, the base set 405 will alert any mobile stations, and also any connected wired telephones, registered in the home network, as described with respect to registration procedures above.

Any mobile station registered in the home network will compose only the call control (CC) 501 and higher application layer parts of the CC messages using any relevant SIM parameters transferred during the registration phase and subsequent SIM parameter updates from the UNC 407 to the base set 405.

As discussed above with respect to FIG. 4, the call control functionality will be controlled by one mobile service end point in the registered network on a per-call basis. Controller functionality will be assigned based on the mobile end point that first initiates an outgoing call or accept the alerts of the incoming call and then responds with a CONFIRMED CC message such as message 425. Additionally, call control may be transferred to an extension as discussed with respect to CONFIRMED CC message 437. Once a mobile service end point is assigned, the home base 405 virtually locks the SIM card from further access by other mobile handsets registered in the network. Any of the other mobiles, and also any connected wired phones, that subsequently join the call could participate in the data transfer but are refrained from sending signaling data.

The mobile with the controller functionality will originate the CC Messages 501. The controlling mobile will likewise be responsible for call setup and management 501, including but not limited to, alerting, call confirmed, call proceeding, connect, connect acknowledge, emergency setup, progress and setup. For example, features such as call clearing, call information, and DTMF may also be accommodated.

In an alternative embodiment, a virtual SIM (soft SIM card) may be employed as described in U.S. Pat. No. 6,466,804 (issued Oct. 15, 2002), “Method and Apparatus for Remote Multiple Access to Subscriber Identity Module,” which is commonly assigned to Motorola, Inc. and which is hereby incorporated by reference herein.

In the alternative embodiment employing a virtual SIM, the virtual SIM may function as a client to the actual SIM which supports the server capability. Rather than having a physical SIM card in each mobile station, that is specific to, and registered in, the base set 405, each mobile station may have a virtual SIM card. The client and server SIM components operate through a series of commands. The virtual SIM of each mobile station is replicated in the personal group of mobile GSM devices registered in the base set 405.

Using the virtual SIM card approach, each mobile station may independently manage the call control signaling for a call, without the base set 405 intercepting the message as discussed with respect to FIG. 4, call control signaling 421 and 423. However, the first mobile station to place or receive a call must still lock the rights to call control signaling functionality with the base set 405 at the beginning of the call as illustrated in FIG. 4 blocks 427 and 439.

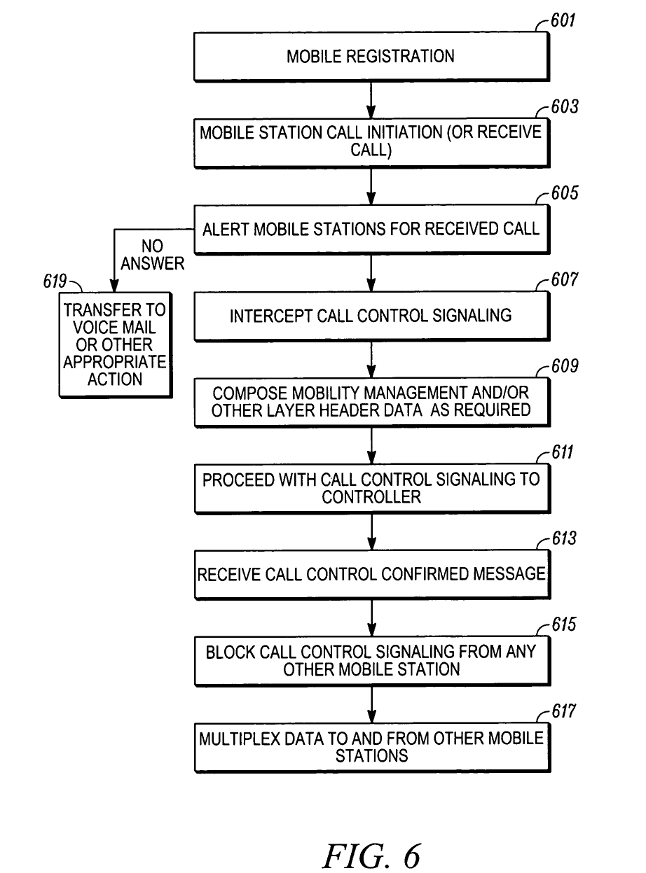

FIGS. 6, 7 and 8 are flow diagrams illustrating operation of a base set in accordance with some embodiments. FIG. 6 illustrates the basic operation wherein mobiles first register with the base set using in some embodiments, their respective MAC-IDs as shown in block 601.

The base set MSISDN may be selected by a registered mobile station to initiate a call as shown in block 603. Additionally, a call may be received by the base set in block 603 in which case the base set will alert the registered mobiles by, for example, sending a paging message to ring the mobiles as shown in block 605. If no mobile station answers then the call may be transferred to voice mail or other appropriate action as shown in block 619.

After a call has been answered, of if a call is initiated, the base set will intercept call control layer signals as shown in block 607. The base set will compose any higher layer message header such as mobility management as shown in block 609. The base set will then proceed to communicate the call control signaling to a UNC as shown in block 611. Note that in the virtual SIM embodiments, this step is not required, because a mobile station may assume call control independently.

A mobile station may send a call control confirmed message which will be received by the base set as shown in block 613. At that point, call control signaling from any other mobile station would be prohibited as shown in block 615. For any other registered mobile station joining the call, for example by picking up the receiver or taking the analogous action, data to and from the joining mobile station will be multiplexed with the initiating mobile data channel as shown in block 617.

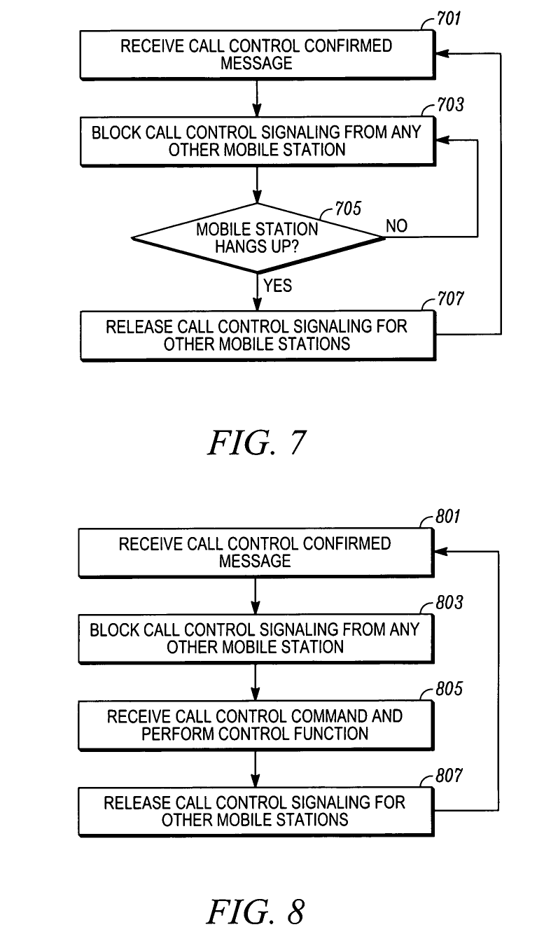

FIG. 7 illustrates an embodiment wherein call control may be transferred from a mobile station that hangs up on a current call. Assuming an existing call, block 701 illustrates the base set receiving a call control confirmed (CONFIRMED CC) message. At that point, call control signaling from any other mobile station is prohibited as illustrated in block 703. However, if the mobile station having control hangs up as shown in block 705, call control will be released for any other mobile station participating in the call as shown in block 707. The mobile station that first transmits the next CONFIRMED CC message as shown in block 701, will then takeover control. As long as the initially controlling mobile station remains in the call, any other mobile station is prohibited from call control signaling.

FIG. 8 illustrates an alternative embodiment to that of FIG. 7. FIG. 8 illustrates an automatic release of call control authority after taking the commanded call control action. Therefore in block 801 a CONFIRMED CC message is received by the base set. Subsequently in block 803, call control from any other mobile station is blocked. A call control command is received in block 805, such as but not limited to, call waiting answer, three-way calling, call hold, etc., and the function is performed. After completion of the function, call control is released to other participating mobile station as shown in block 807. The next mobile station to transmit the CONFIRMED CC message as shown in block 801 will then assume control authority. Therefore for example, if several mobile stations are participating in a call, one may assume control to answer a call waiting, return to the initial call, and then relinquish control for subsequent actions by other participating mobile stations.

In some embodiments, the base set may be programmable such that mobile stations may receive calls using either their cellular MSISDN or the base set MSISDN. However, generally in most embodiments, the individual MSISDNs of the mobile stations registered with the base set will be transparent to the UNC.

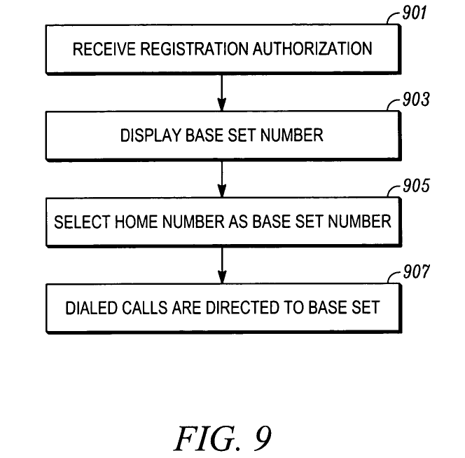

In FIG. 9, a mobile station capability of selecting which number to use for home calls is illustrated. A mobile station, which has its MAC-ID stored in the base set as discussed previously, may register with the base set and receive registration authorization as shown in block 901. The mobile station display will receive the base set number, for example a cellular network MSISDN as shown in block 903. The mobile station may, in some embodiments, select the base set number for placing and receiving calls while registered in the home network as shown in block 905. Therefore, if the base set number has been selected, calls placed by the mobile station will be directed to the base set over the VoIP stack of the mobile as shown in block 907.

Additional messaging may also occur in some embodiments such that a mobile station may receive calls while registered by the base set. For example, returning to FIG. 3, if mobile station 323 is registered and selects the base set 301 number or MSISDN for receiving calls, the mobile station 323 may send an indication message to base set 301. The base set 301 may further communicate with UNC 317 to inform the cellular network 319 of the selection. A procedure may then be implemented within the cellular network, such as call forwarding of incoming calls to the mobile station 323 number to the base set 301 number. However, in some embodiments as previously discussed, the UNC 317 appears as a BSC/BTS to the cellular network 319. Therefore, calls for mobile station 323 that are incoming to cellular network 319 may be routed normally as would occur had the mobile station been located within a cellular network 319 BTS coverage area, that is, to the UNC 317 which functions as a BSC/BTS with respect to cellular network 319.

The base set 301 may have a programmable feature such that additional mobile stations may be added to the home, or enterprise network by programming the respective mobile station MAC-ID, or other similar relevant registration information, into a memory of the base set 301. Therefore, numerous devices may be allowed to register with the base set 301. Further, the base set 301 may function with mobile stations employing any wireless technology such as GSM, CDMA, UMTS etc. The base set may comprise radio baseband and other stack layers as necessary to accommodate such devices. In the various embodiments, unlicensed radio links are used by the base set to communicate with the mobile stations such as but not limited to Bluetooth™, and 802.11.

While various embodiments have been illustrated and described, it is to be understood that the disclosure is not so limited. Numerous modifications, changes, variations, substitutions and equivalents will occur to those skilled in the art without departing from the spirit and scope of the present invention as defined by the appended claims.

What is claimed is:

1. A base unit comprising:
a processor;
a memory coupled to said processor;
a cellular network logical identifier, corresponding to a subscription on a cellular network, stored in said memory; and
registration information for at least one mobile station stored in said memory.

2. The base unit of claim 1, wherein said processor further comprises:
a call control command module, for receiving a call control confirmed command from a mobile station having said registration information stored in said memory, and thereafter for blocking call control commands from any other mobile station.

3. The base unit of claim 1, wherein said processor further comprises:
a Voice-over-Internet-Protocol (VoIP) stack.

4. The base unit of claim 3, further comprising:
a wireless transceiver having a wireless interface protocol stack coupled thereto; and
wherein said processor further comprises a mobility management stack.

5. The base unit of claim 4, wherein said processor further comprises:
a multiplexing module, for multiplexing VoIP packets to and from any wireless device having registration information stored in said memory.

6. The base unit of claim 5, wherein said processor further comprises:
a broadcast module, for broadcasting an alert of an incoming call, directed to said cellular network logical identifier, to any mobile station having registration information stored in said memory.

7. The base unit of claim 6, wherein said registration information is a Media Access Control Identifier (MAC-ID) corresponding to a wireless device subscribed to said cellular network.

8. The base unit of claim 7, wherein said processor further comprises:
a registration module, for
receiving a registration request from a first wireless device;
transmitting a registration authorization message to said first wireless device if said memory contains registration information corresponding to said first wireless device;
establishing a call control service point with said cellular network for said first wireless device; and
blocking other wireless devices having registration information in said memory from access to call control signalling.

9. The base unit of claim 1 wherein said cellular network logical identifier is a cellular network Subscriber Identity Module.

10. A method of operating a base unit comprising:
intercepting a call control signaling from a first mobile station;
composing header data for lower layer call signaling layers including a mobility management layer;
combining said header data with said call control signaling to create a complete signaling; and
routing the complete signaling to a controller.

11. The method of claim 10, further comprising:
blocking call control signaling from a second mobile station.

12. The method of claim 11, further comprising:
receiving a hang-up indication from said first mobile;
releasing call control blocking of said second mobile station;
receiving a call control confirmation message from said second mobile station; and
blocking call control signaling from said first mobile station.

13. The method of claim 11, further comprising:
receiving a call control command from said first mobile station;
performing a control function corresponding to said call control command;
releasing call control blocking of said second mobile station;
receiving a call control confirmation message from said second mobile station; and
blocking call control signaling from said first mobile station.

14. A mobile station comprising:
a wireless transceiver;
a Voice-Over-IP (VoIP) stack coupled to said wireless transceiver;
a registration module for registering with a base set; and
a command module for commanding a base set to accept call control signaling only from said mobile station.

15. The mobile station of claim 14, further comprising:
a base set number selection module, for selecting to receive calls from said base set number.

16. The mobile station of claim 15, further comprising:
a virtual Subscriber Identity Module (SIM) client for receiving downloaded SIM information from a base set.

17. The mobile station of claim 16, wherein said wireless transceiver is a WLAN transceiver, and further comprising a second wireless transceiver.

18. The mobile station of claim 17, wherein:
said WLAN transceiver is coupled to one of a Bluetooth stack, an 802.11 stack, or an 802.16 stack; and
said second wireless transceiver is coupled to one of a GSM stack, a CDMA stack, or a UMTS stack.
